(19) United States
(12) Patent Application Publication
(10) Pub. No.: US 2003/0178218 A1
(43) Pub. Date: Sep. 25, 2003

(54) Outlet cover

(75) Inventors: Michael J. Shotey, Scottsdale, AZ (US); Marcus J. Shotey, Scottsdale, AZ (US); Edgar Maltby, Mesa, AZ (US)

Correspondence Address: Niro, Scavone, Haller & Niro, Suite 4600, 181 W. Madison, Chicago, IL, 60602, US

(73) Assignee: TayMac Corporation

(21) Appl. No.: 10/104,733

(22) Filed: Mar. 22, 2002

(51) Int. Cl. H02G 3/14

(52) U.S. Cl. 174/66

(57) ABSTRACT

The present invention concerns an outlet cover for mounting to an electrical box through the use of box screws, device mounting screws, or both. The cover, which may be made from die-casting techniques, includes a base having a raised body portion and a plurality of corners. Each of the corners may have slots, keyholes or a combination of either which are sized to receive a box screw for securing the cover to the outlet box. The raised body portion has a sidewall and a planar section. The sidewall spaces the planar section away from the four corners so as to recess the corners with respect to said planar section. A plurality of knockouts may also be used which permit the cover to be configurable to accommodate electrical devices such as toggle switches, GFCI outlets, duplex outlets, and circular outlets. The knockouts may face inwardly.

### BACKGROUND OF THE INVENTION

The present invention relates to electrical outlet covers that enclose wiring and electrical devices such as ground fault circuit interrupt outlets, duplex outlets, round outlets, toggle switches and the like that are installed in electrical boxes. More specifically, the invention relates to an outlet cover that has quick connect slots or keyhole shaped openings and the capability to accommodate two duplex outlets or two ground fault circuit interrupt (“GFCI”) outlets, or combinations thereof, as well as other electrical devices.

### SUMMARY OF THE INVENTION

While there are a number of outlet covers that cover double gang applications, none are presently known to include features which permit the quick and efficient installation of the cover. To install an outlet cover, the cover is often secured to box screws or fasteners which are attached to the corners of the junction or outlet box. Apertures are typically located on the cover to receive the fasteners from the box which must first be removed then re-inserted through the apertures and threaded until the fastener head engages the cover. As is often the case, the junction box may be full of wiring which makes it difficult to easily align the fasteners, apertures, and other components for easy installation. Even the seemingly simple task of removing the pre-installed fasteners from the box is not without its difficulties. The small fasteners tend to get lost and proper alignment is required for re-threading.

Installation is often made even more difficult by the fact that the boxes are often positioned in relatively inaccessible locations. It is not uncommon to find junction boxes near floors, in elevated positions which require the use of a ladder, and in other locations which limit access or range of movement of the installer.

To reduce the difficulties of installation, slots are often used in the place of the apertures in the outlet cover that are single gang in application. Using slots does not require the removal of the fasteners from the outlet box. Instead the slots permit the cover to be positionable about the fasteners to achieve proper alignment.

For double gang application, the use of slots has not been possible in known outlet cover designs. This is the result of the typical metal cover being manufactured from punch-press techniques. Due to the limitations of this technique, there is not enough material and spacing to create an outlet cover that includes both slots for ease of installation and the necessary openings to accommodate electrical devices in a double gang application. Therefore, there is a need for an outlet cover that accommodates double gang applications and which is easily installed.

The present invention overcomes the above mentioned problems by providing an outlet cover for mounting to an electrical box through the use of a base having a raised body portion and a plurality of corners with each corner having slots sized to receive a box screw. The raised body portion has a sidewall and a planar section. The sidewall spaces the planar section away from the four corners so as to recess the corners with respect to the planar section. The planar section has a plurality of knockouts which permit the cover to be used with both ground fault circuit interrupt electrical devices and duplex electrical devices through the formation of openings. In another embodiment, keyhole shaped openings are used instead of slots.

It is a further object of the invention to provide an outlet cover which includes a plurality of stops which depend from said base in a direction opposite the sidewall. Another object of the invention is to provide an outlet cover that has angled slots to permit the cover to be rotated into position with respect to an electrical box.

Yet another object of the invention is to provide a raised sidewall which includes indentations adjacent the slots for ease of access by a tool.

Still another object of the invention is to create an outlet cover that includes two opposingly located stops that promote proper alignment and hold the cover in place.

Another object of the invention is to also provide four opposingly located stops.

An object of the invention is to provide an outlet cover made from die-casting.

Yet another object of the present invention is to employ keyholes for quick and efficient mounting.

### DESCRIPTION OF THE DRAWINGS

These and other features, objects and advantages of the present invention will become apparent from the following description and drawings wherein like reference numerals represent like elements in several views, and in which:

FIG. 1 is an exploded perspective view of an embodiment of the present invention.

FIGS. 2A-2C are a top view of an embodiment of the present invention illustrating how a keyhole interacts with a fastener.

FIG. 3 is a bottom view of an embodiment of the present invention.

FIG. 4 is a cross-sectional view of the embodiment shown in FIG. 2 taken along line 3-3.

FIG. 5 is a bottom view of another embodiment of the present invention.

FIG. 6 is a bottom view of an alternate embodiment of the present invention.

FIG. 7 is a side view of the embodiment shown in FIG. 6.

FIG. 8 is a bottom view of another embodiment of the present invention.

FIG. 9 is a side view of the embodiment in FIG. 8.

FIG. 10 is a top view of the embodiment shown in FIG. 8.

FIG. 11 is an exploded view of the corner shown in FIG. 10.

FIG. 12 is an exploded view of the corner shown in FIG. 8.

FIG. 13 is a bottom-perspective view of an embodiment of the present invention.

### DESCRIPTION OF THE PREFERRED EMBODIMENTS

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

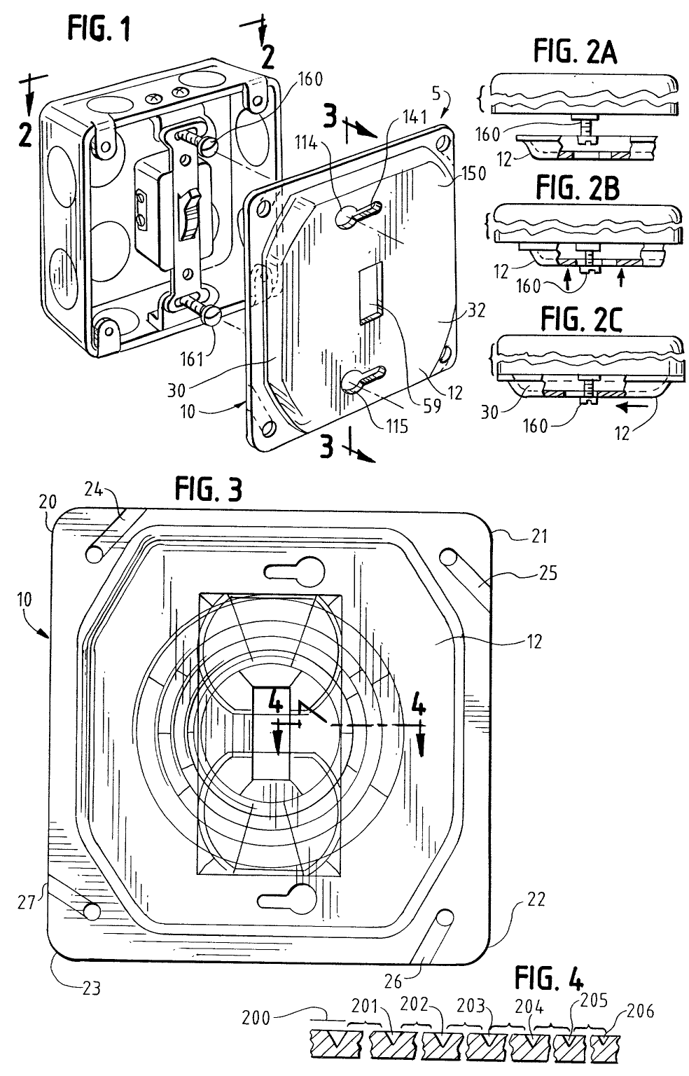

FIGS. 1-4 illustrate an embodiment of the present invention. Outlet cover 5 includes a base 10 having a raised body portion 12 and a plurality of corners 20-23. Slots 24-27 are formed in each of the corners, and the slots may be angled with respect to the edges of the base 10. Slots 24-27 are sized to receive the shank portion of the fastener or mounting screw (not shown) and to permit the corners to engage the head portion of the fastener.

Raised body portion 12 is comprised of a sidewall 30 and planar section 32. Corners 20-23 are recessed with respect to planar section 32 as a result of their position with respect to raised sidewall 30. Slots 24-27 may be located adjacent to indented portions 40-43. The indentations allow a tool to easily access the fasteners.

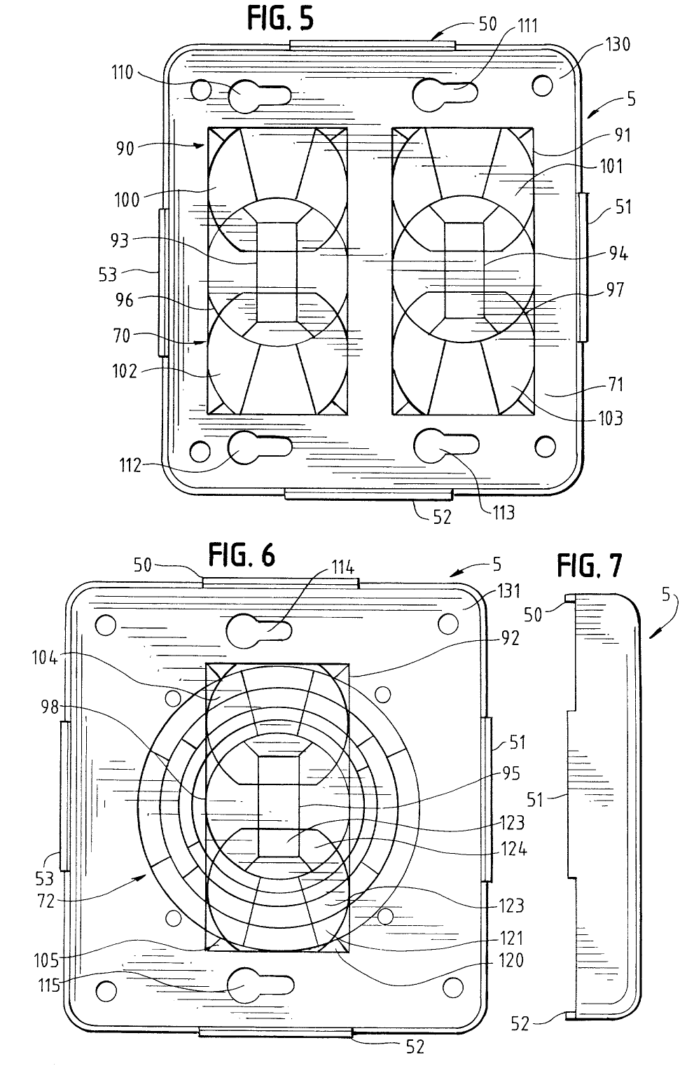

As illustrated in FIGS. 5-8, stops 50-53 may depend from base 10. Stops 50-53 are configured to engage the outside edges of an outlet box. Stops 50-53 hold cover 5 in proper alignment on a box by preventing unwanted twisting. The stops also assist in indicating that the cover is properly positioned on a box as well. While four stops are shown, a combination of two stops located on either adjacent edges or opposing edges may also be employed.

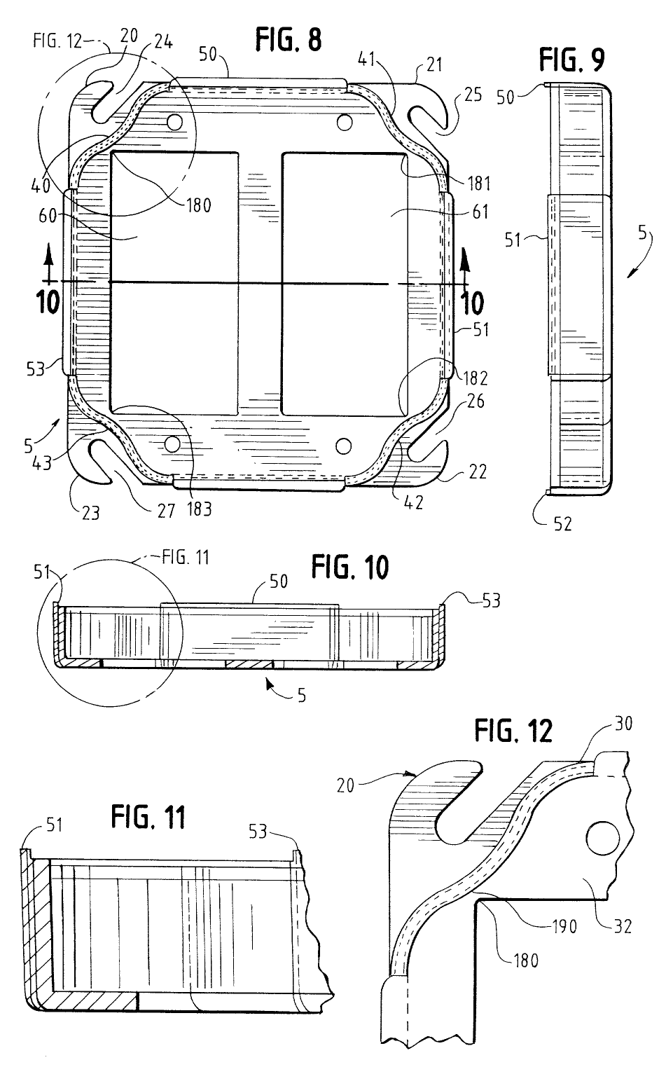

Planar 32 section is configured to receive electrical devices. This is accomplished by either dedicated openings 59, 60 and 61 as shown in FIGS. 1 and 8. Alternately, the planar section may include groupings of knockouts which permit the outlet cover to accommodate any number of different electrical devices as shown in FIGS. 3, 5 and 6. The groupings of knockouts are collectively designated 70 and 71 in FIG. 5 and 72 in FIG. 6.

Knockout groupings 70 and 71 are similar in design. The knockouts are arranged to permit the cover to accommodate a wide number of electrical devices through the formation of different openings. The electrical devices which may be accommodated include a large rectangularly shaped GFCI designated by lines 90-92, a smaller rectangularly shaped toggle switch designated by lines 93-95, a circular shaped outlet designated by lines 96-98 and the somewhat circular shapes of duplex devices designated by lines 100-105. Knockout grouping 72 permits use with successively larger shaped circular outlets. The knockout groupings may also be used in connection with the cover shown in FIG. 1.

As illustrated, knockout groupings are further comprised of a plurality of separate sections which permit the cover to accommodate a variety of electrical devices. Some, but not all of the pieces or sections that comprise the knockout groupings are designated with numbers 120-125 on FIG. 6. In addition, to improve the appearance of the cover, and to inhibit tampering, it has been found that the knockouts should be formed on the bottom or inside surface 130 or 131 of the cover 5 so as to face inwardly. This results in the top or outward surface 150 of cover 5 having a finished appearance as shown in FIG. 1.

As shown in FIGS. 5 and 6, no corner slots are employed on the embodiments shown. Instead, keyholes 110-115 are used for double gang application. The keyholes are located in the position where the electrical device mounting screws are located. By electrical device mounting screws it is meant the fasteners which secure the electrical device to the junction or electrical box as shown in FIG. 1 where the fasteners are designated 160 and 161. For single gang applications, the cover may include similar keyholes 114-115 as shown in FIG. 6.

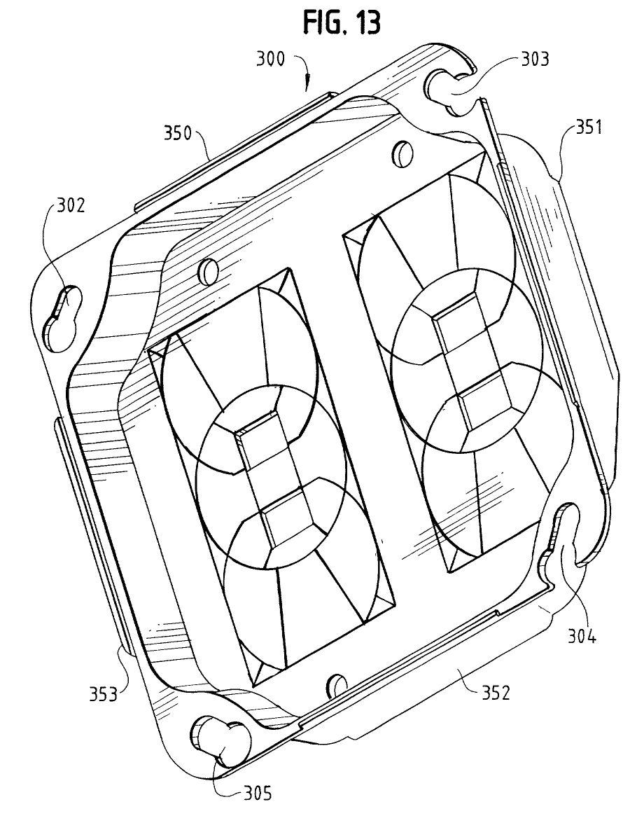

To manufacture a cover such as shown in FIGS. 8 and 12, it has been found that traditional stamping techniques are insufficient to create the embodiments of the present invention which use slots at the corners of the cover. Due to limitations in stamping techniques, there is generally not enough material in the blank to form a double gang type of cover plate that includes recessed corners 20-23, sidewall 30, along with openings 60 and 61 that may accommodate GFCI outlets. The limitations of stamping results in the inability to form a support span between the outer edge of corners 180-183 of openings 60 and 61 and the raised sidewall 30. FIG. 12 illustrates how a support section 190 of planar section 32 needs to span from corner 180 to sidewall 30. This span is needed to provide support for use in the double gang applications described above.

Stamping techniques do not result in the formation of section 190. To create the necessary support provided by section 190, it has been found that die-casting is a suitable method of manufacture to create an optimal span. This technique of manufacture does not require the bending and stretching of a blank and, as a result, a suitable cover may result. Of course, other known techniques which do not require the bending and stretching of material will work as well.

As shown in FIG. 4, when forming the knockout groupings, score lines 200-206 may be used. To facilitate the configuration of the knockouts it has been found that the depth of the scoring may vary with the greatest depth being generally located at or near the center and with decreased depth being used at the outer sections. Since the knockout sections located near the center are the ones which are most often removed, a deeper scoring facilitates their removal. In addition, less scoring depth on the outer regions creates a stronger device since these knockout sections are not generally used when configuring the device.

As shown in FIG. 13, in another embodiment of the invention, cover 300 includes keyholes 302-305 formed at the corners of the cover to facilitate installation. The keyholes are angled with respect to the sides of the cover. This permits a turning motion for properly positioning a fastener in the keyhole for the mounting of the cover. As shown, the keyholes may be closed as shown by keyhole 302 or open as shown by keyhole 303.

The various cover embodiments discussed above may be quickly and easily mounted in a number of different ways. For example, as shown above, the covers may employ both slots and keyholes. To install a cover employing slots, the cover may be installed by simply aligning slots 24-27 so that the shank portions of the fasteners, which are typically pre-installed on the box, are engaged. The cover is then rotated until the stops engage the outer edges of the box. This indicates proper alignment and prevents any unwanted twisting. The fasteners are then tightened to complete the process. If groupings of knockouts are provided, the cover should be first configured to accommodate the desired electrical device or devices.

To install covers that use keyholes, the device screws are first inserted through the larger openings in the keyholes as illustrated in FIGS. 2A-2C. The cover is then slid into position until the shank of the screw is located inside the smaller keyhole section 141. The screws are then tightened. Again, the plurality of stops 50-53 may also be used with this embodiment to indicate proper alignment and to prevent twisting of the cover.

The cover shown in FIG. 13 is also installed in a similar manner. First, the box screws are inserted into the portion of the keyhole which is sized to receive the fastener head. Next, the cover is rotated so that the reduced keyhole area is located under the fastener head. Each fastener is then tightened so that the head engages the cover. Stops 350-353 may be used to indicate proper alignment and to prevent twisting.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. An outlet cover for mounting to an electrical box through the use of box screws comprising:
a base having a raised body portion and a plurality of corners, each of said corners having slots sized to receive a box screw;
said raised body portion having a sidewall and a planar section, said sidewall spaces said planar section away from said four corners so as to recess said corners with respect to said planar section;
said planar section having a plurality of knockouts, said knockouts permit said cover to be used with a plurality of electrical devices.

2. The outlet cover of claim 1 wherein a plurality of stops depend from said base in a direction opposite said sidewall, said stops spaced apart to engage an electrical box.

3. The outlet cover of claim 1 wherein said slots are angled to permit said cover to be rotated into position with respect to an electrical box.

4. The device of claim 1 wherein said raised sidewall includes indentations adjacent said slots.

5. The outlet cover of claim 1 wherein said knockouts face inwardly.

6. The outlet cover of claim 1 wherein said base includes opposingly located stops.

7. The outlet cover of claim 1 wherein said base is made from die-casting.

8. The outlet cover of claim 1 wherein said base includes at least two adjacently located stops.

9. The outlet cover of claim 1 wherein said cover is configurable to accommodate either a duplex outlet or GFCI outlet.

10. An outlet cover for mounting to an electrical box through the use of electrical device mounting screws comprising:
a base having a planar section including a plurality of knockouts, said knockouts permit said cover to be used with a plurality of electrical devices;
a plurality of keyholes located on said base, said keyholes positioned to receive electrical device mounting screws whereby said cover is securable to said box.

11. The outlet cover of claim 10 whereby a plurality of stops depend from said base, said stops spaced apart to engage an electrical box.

12. The outlet cover of claim 10 wherein said knockouts face inwardly.

13. The outlet cover of claim 10 wherein said base includes opposingly located stops.

14. The outlet cover of claim 10 wherein said base is made from die-casting.

15. The outlet cover of claim 10 wherein said base includes at least two adjacently located stops.

16. The outlet cover of claim 10 wherein said cover is configurable to accommodate either a duplex outlet or GFCI outlet.

17. A method for manufacturing an outlet cover for mounting to an electrical box through the use of box screws comprising:
die-casting a base, said base having a raised body portion and a plurality of corners, each of said corners having slots sized to receive a mounting screw;
said raised body portion having a sidewall and a planar section, said sidewall spaces said planar section away from said four corners so as to recess said corners with respect to said planar section;
said planar section having a plurality of knockouts, said knockouts permit said cover to be used with both ground fault circuit interrupt electrical devices and duplex electrical devices through the formation of openings in said die-cast base.

18. The method of claim 17 wherein said die-case base has a plurality of stops depending from said base in a direction opposite said sidewall, said stops spaced apart to engage an electrical box.

19. The method of claim 17 wherein said slots are die-cast and angled to permit said cover to be rotated into position with respect to an electrical box.

20. The method of claim 17 wherein said raised sidewall of said die-cast base includes indentations adjacent said slots.

21. The method of claim 17 wherein said knockouts face inwardly.

22. The method of claim 17 wherein said die-cast base includes opposingly located stops.

23. The method of claim 17 wherein said die-cast base includes at least two adjacently located stops.

24. The cover of claim 1 wherein said cover includes knockouts that are configurable to accommodate a GFCI outlet, a toggle switch, a circular outlet, or a duplex outlet.

25. The cover of claim 10 wherein said cover includes knockouts that are configurable to accommodate a GFCI outlet, a toggle switch, a circular outlet, or a duplex outlet.
